(19) United States
(12) Patent Application Publication
(10) Pub. No.: US 2022/0080787 A1
(43) Pub. Date: Mar. 17, 2022

(54) TIRE SENSOR CONFIGURING DEVICE AND SMART TIRE SYSTEM INCLUDING THE SAME

(71) Applicant: KUMHO TIRE CO., INC., Gwangju (KR)

(72) Inventors: Hyungseok KIM, Yongin-si (KR); Hyounjung KIM, Yongin-si (KR)

(21) Appl. No.: 17/469,205

(22) Filed: Sep. 8, 2021

(30) Foreign Application Priority Data
Sep. 14, 2020 (KR) 10-2020-0117887

(51) Int. Cl. B60C 23/04; B60C 23/00

(52) U.S. Cl. CPC B60C 23/0416; H04L 67/12; B60C 23/001

(57) ABSTRACT

This application relates to a tire sensor configuring device and a smart tire system including the same. In one aspect, the tire sensor configuring device includes a transceiver receiving a communication module identification code of a communication module provided in a vehicle to communicate with a smart tire management server, tire identification codes of a plurality of tires mounted to the vehicle, and sensor identification codes of sensor modules respectively attached to the plurality of tires. The tire sensor configuring device may also include a controller configured to arrange the communication module identification code, the tire identification codes, and the sensor identification codes according to a protocol previously created in association with the smart tire management server to form a packet. The transceiver transmits the packet to the communication module.

### CROSS-REFERENCE TO RELATED APPLICATION

This application claims priority to Korean Patent Application No. 10-2020-0117887 filed on Sep. 14, 2020, the disclosures of which are incorporated herein in its entirety by reference for all purposes.

### TECHNICAL FIELD

The present disclosure relates to a tire sensor configuring device and a smart tire system including the same.

### BACKGROUND

Recently, as an automobile-based technology, research on fuel efficiency, driver convenience, and driving stability improvement is being actively conducted. In particular, active vehicle body stabilization devices such as a tire pressure monitoring system (TPMS), an anti-brake system (ABS), and an electronic stability program (ESP) are becoming common, autonomous vehicles are becoming common, and thus, technologies for more effectively measuring road surface information and tire condition information are researched.

For example, a smart tire system that monitors a condition of a tire by attaching a sensor module to an inside of the tire is a representative example.

### SUMMARY

An embodiment of the present disclosure is directed to providing a smart tire system including a tire sensor configuring device that operates a sensor module attached to a tire of a vehicle to manage information on the tire in a field of a smart tire system.

In addition, an embodiment of the present disclosure is directed to forming a packet including the tire information according to a protocol that can be handled by a smart tire management server constituting the smart tire system and providing the packet to the smart tire management server.

In accordance with a first embodiment of the present disclosure, there is provided a tire sensor configuring device including: a transceiver receiving a communication module identification code of a communication module provided in a vehicle to communicate with a smart tire management server, tire identification codes of a plurality of tires mounted to the vehicle, and sensor identification codes of sensor modules respectively attached to the plurality of tires; and a controller configured to arrange the communication module identification code, the tire identification codes, and the sensor identification codes according to a protocol previously created in association with the smart tire management server to form a packet, wherein the transceiver transmits the packet to the communication module.

The packet may further include location information of the plurality of tires.

The protocol may define a location where the tire identification code and the sensor identification code are stored in the packet for each tire.

The transceiver may include: a transmitter configured to transmit a communication module identification code request signal to the communication module; and a receiver configured to receive the communication module identification code transmitted from the communication module in accordance with the communication module identification code request signal, wherein the receiver receives the sensor identification code and the tire identification code after the receiver receives the communication module identification code.

The transmitter may transmit a power signal for operating the sensor module to the sensor module after the receiver receives the communication module identification code.

In accordance with a second embodiment of the present disclosure, there is provided a smart tire system including: a communication module communicating with a smart tire management server, provided in a vehicle including a plurality of tires, and configured to store a communication module identification code; a sensor module provided in each of the plurality of tires and storing a sensor identification code; a tag provided in each of the plurality of tires and storing a tire identification code; and a tire sensor configuring device communicating with the communication module, the sensor module, and the tag, wherein the tire sensor configuring device includes: a controller configured to arrange the communication module identification code transmitted from the communication module, the sensor identification code transmitted from the sensor module, and the tire identification code transmitted from the tag according to a protocol previously created in association with the smart tire management server to form a packet; and a transceiver transmitting the packet to the communication module.

The protocol may define a location where the tire identification code and the sensor identification code are stored in the packet for each tire.

According to the protocol previously created in the tire sensor configuring device included in the smart tire system according to the embodiment of the present disclosure, the packet for storing a sensor identification code of the sensor module and a tire identification code of the tire is formed, the packet is transmitted to the smart tire management server, and thus, the data of the tire can be efficiently managed by the smart tire management server.

The transmitter includes an LF transmitter, a communication unit of the sensor module includes an LF receiver, and thus, the sensor module can be operated without providing a separate power supply in the sensor module.

### BRIEF DESCRIPTION OF THE DRAWINGS

FIG. 1 is a view schematically showing a smart tire system according to an embodiment of the present disclosure.

FIG. 2 is a block diagram of a tire sensor configuring device according to the embodiment of the present disclosure.

FIG. 3 is a diagram showing a protocol formed by the tire sensor configuring device according to the embodiment of the present disclosure.

### DETAILED DESCRIPTION

In a smart tire system, a tire air pressure, a temperature, or the like is measured using the sensor module, tire state information is stored on a server or in a cloud, and thus, data on tires of multiple vehicles may be collected and managed at once. Meanwhile, in the case of the sensor module in the smart tire system, since the sensor module is attached to an inner liner of the tire, weight and size of the sensor module are limited. Moreover, in preparation for contamination that may occur inside the tire, the sensor module should be completely packed and manufactured. Accordingly, the sensor module has a problem in that it is difficult to provide a separate power supply as hardware.

In addition, in order for the data collected by the sensor module to be efficiently managed on a server or the like, information on a communication module mounted on the sensor module, tire, and vehicle should be transmitted to the server using a protocol that can be handled or managed by the server.

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, ‘accessed’ to, ‘supplied’ to, ‘transferred’ to, or ‘contacted’ with another element, it should be understood that the element may be directly connected to, supported by, accessed to, supplied to, transferred to, or contacted with another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

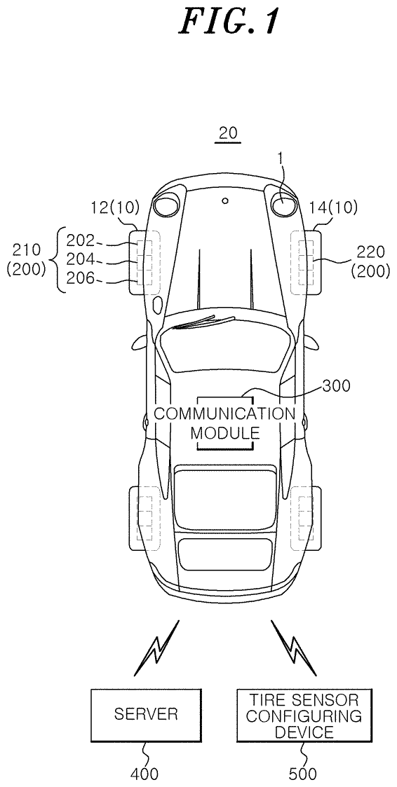

Hereinafter, a smart tire system 20 according to an embodiment of the present disclosure will be described with reference to FIGS. 1 to 3.

Referring to FIG. 1, the smart tire system 20 according to the embodiment of the present disclosure may include a plurality of sensor modules 200, a communication module 300, a smart tire management server 400, and a tire sensor configuring device 500.

The plurality of sensor modules 200 may be each provided at a plurality of tires 10 provided in a vehicle 1. The sensor module 200 may be mounted on an inner liner of each tire 10. The sensor module 200 collects tire data such as a temperature, an acceleration, and a wear state of the tire 10 and transmits the tire data to the communication module 300 attached to the vehicle 1. As shown in FIG. 1, the vehicle 1 is shown as a vehicle including four tires 10, but the present disclosure is not limited thereto.

In addition, each of the plurality of sensor modules 200 may store different sensor identification codes, and when the sensor module 200 is operated by the tire sensor configuring device 500, the sensor module 200 may transmit the sensor identification code to the tire sensor configuring device 500.

According to the above, the sensor module 200 may include a sensor unit 202, a communication unit 204, and a sensor storage unit 206.

The sensor unit 202 collects tire data such as the temperature, acceleration, and wear state of the tire 10. The sensor unit 202 can be driven by a separate power supply.

The communication unit 204 transmits tire data to the communication module 300 or the sensor identification code to the tire sensor configuring device 500. The communication unit 204 may include a long frequency (LF) receiver that communicates with a long frequency method. Accordingly, when the communication unit 204 receives a power signal transmitted from the tire sensor configuring device 500, the LF receiver generates a wake-up signal, and power is applied according to the wake-up signal to operate the sensor module 200. Therefore, the communication unit 204 may transmit the sensor identification code to the tire sensor configuring device 500.

The sensor storage unit 206 may store the sensor identification code, and may store tire data collected from the sensor unit 202 as the sensor module 200 operates. Here, the sensor storage unit 206 may include a memory such as a dynamic random access memory (DRAM) or a NAND.

For example, among the plurality of sensor modules 200, a first sensor module 210 attached to a first tire 12 may include a first sensor identification code, and a second sensor module 220 attached to a second tire 14 may include a second sensor identification code. In this case, when a power signal is transmitted to the LF receiver of the first sensor module 210, the first sensor identification code stored in the sensor storage unit 206 of the first sensor module 210 may be transmitted to the tire sensor configuring device 500 through the communication unit 204 of the first sensor module 210. Then, when the power signal is transmitted to the LF receiver of the second sensor module 220, the second sensor identification code of the sensor storage unit 206 of the second sensor module 220 may be transmitted to the tire sensor configuration device 500 through the communication unit 204 of the second sensor module 220.

The communication module 300 is installed in the vehicle 1, and serves to transmit/receive data on a plurality of tires 10 to/from the smart tire management server 400 or to/from the tire sensor configuring device 500. For example, the communication module 300 receives a packet formed in accordance with a protocol P from the tire sensor configuring device 500 and transmits the packet to the smart tire management server 400. For example, the communication module 300 and the smart tire management server 400 may communicate in a long-term evolution (LTE) manner and may communicate in a radio frequency (RF) manner with the tire sensor configuring device 500, but the present disclosure is not limited thereto.

Here, the protocol refers to various communication protocols established to facilitate an exchange of information between devices. Accordingly, the protocol applied to the present disclosure may define a location in which the tire identification code and the sensor identification code are stored in the packet P for each of a plurality of tires 10. This will be described in detail below.

In addition, the communication module 300 may include a unique communication module identification code.

As the smart tire management server 400 communicates with the communication module 300 mounted on the vehicle 1, the smart tire management server 400 may receive the packet P configured according to a protocol from the tire sensor configuring device 500. In addition, the smart tire management server 400 may manage the tire data included in the packet P for each vehicle, and may provide information related to the tire data to a user of the vehicle 1.

The tire sensor configuring device 500 controls the plurality of sensor modules 200, communicates with the plurality of sensor modules 200 in order to configure the plurality of sensor modules 200, and forms the packet P according to a protocol to transmit the packet P to the smart tire management server 400.

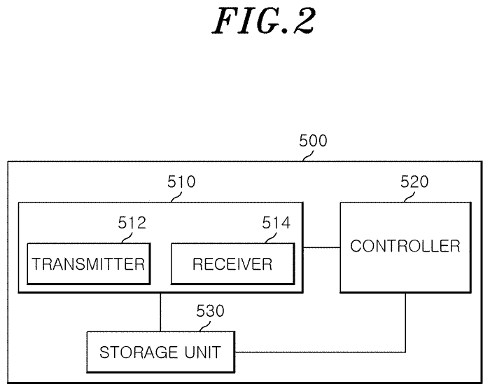

Referring to FIG. 2, the tire sensor configuring device 500 may include a transceiver 510 and a controller 520, and a storage unit 530.

The transceiver 510 receives the communication module identification code of the communication module 300, the tire identification code of each tire 10, and the sensor identification code of each sensor module 200, and transmits the packet formed by the controller 520 to the communication module 300 again. A tag for storing a tire identification code may be formed at each of the plurality of tires 10, and the tag may include a radio frequency identification (RFID) tag to communicate with the transceiver 510.

The transceiver 510 may include a transmitter 512 and a receiver 514.

The transmitter 512 transmits various signals to the communication module 300 and the sensor module 200 to receive a plurality of sensor identification codes and a plurality of tire identification codes as the transmitter 512 controlled by the controller 520. Specifically, the transmitter 512 may send a communication module identification code request signal to the communication module 300, and when the communication module identification code transmitted from the communication module 300 is received by the receiver 514, the transmitter 512 may be controlled by the controller 520 to sequentially transmit a power signal for operating the sensor module 200 to the plurality of sensor modules 200.

The transmitter 512 may include an LF transmitter that communicates with the LF receiver of each sensor module 200, and according to a protocol definition, the power signal may be transmitted to a plurality of sensor modules 200 by the LF transmitter. In addition, the transmitter 512 may further include a radio frequency (RF) transmitter, a long-term evolution (LTE) modem, and the like. In particular, as described above, since the protocol can define the location where the tire identification code and the sensor identification code are stored in the packet P for each tire or for each tire location, the power signal may be sequentially transmitted to the plurality of sensor modules 200 according to the order of tire locations defined in the protocol.

According to the above, the transmitter 512 is controlled by the controller 520 according to the protocol definition, and first transmits the power signal to the first sensor module 210 to operate the first sensor module 210. After the first sensor identification code is received by the receiver 514, the transmitter 512 may transmit the power signal to the second sensor module 220 to operate the second sensor module 220 so that the second sensor identification code is received. Accordingly, the receiver 514 may sequentially receive the sensor identification code and tire identification code for each tire, and the sensor identification code and tire identification code may be stored in the packet P formed by the controller in the order received by the receiver 514. In addition, the transmitter 512 may transmit the packet P formed by the controller 520 to the communication module 300 according to the protocol definition.

The receiver 514 may receive the identification code from tags provided in the communication module 300, the plurality of sensor modules 200, and the plurality of tires 10. Accordingly, the receiver 514 may receive the communication module identification code transmitted from the communication module 300, and may receive the sensor identification code transmitted from the sensor module 200 operated by the power signal and the tire identification code of the tire to which the operated sensor module is attached.

The receiver 514 may include an RFID communication unit 204 that communicates with a tag attached to the tire to receive a tire identification code. The RFID communication unit 204 may be activated by the controller 520.

Accordingly, the receiver 514 may sequentially receive the plurality of sensor identification codes and the plurality of tire identification codes according to the power signal sequentially transmitted according to the protocol definition from the transmitter 512.

For example, when the receiver 514 receives the first sensor identification code of the first sensor module 210 that has received the power signal, the receiver 514 is controlled by the controller 520 and communicates with the tag of the first tire 12 to which the first sensor module 210 is attached, and thus, the receiver 514 may receive the first tire identification code. Then, when the receiver 514 receives the second sensor identification code of the second sensor module 220 that has received the power signal, the receiver 514 is controlled by the controller 520 and communicates with the tag of the second tire 14 to which the second sensor module 220 is attached, and thus, the receiver 514 may receive the second tire identification code.

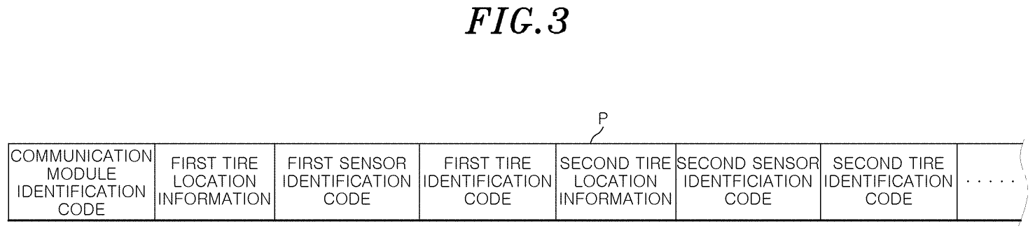

The controller 520 controls the transceiver 510, and according to the protocol previously negotiated with the smart tire management server 400, the controller 520 forms the location information of the plurality of tires 10, the communication module identification code, the plurality of sensor identification codes, the packet P storing the plurality of tire identification codes, as shown in FIG. 3.

Accordingly, the controller 520 may form the packet P for storing the plurality of sensor identification codes, the plurality of tire identification codes, and the plurality of tire location information received from the receiver 514 for each tire location in the order of protocol definition, and transmit the packet P to the communication module 300.

Moreover, the controller 520 may allocate information to each of a plurality of location information.

Here, allocation information may include numbers or letters. For example, a number assigned to the location information of the first tire may be set to No. 1, and a number assigned to the location information of the second tire may be set to No. 2. When the allocation information includes characters, a character assigned to the first tire location information may be stored as a character representing a front left, and a character assigned to the second tire location information may be stored as a character representing a front right.

In addition, each allocation information may correspond to each location where the tire identification code and the sensor identification code are stored in the packet P for each of the plurality of tires defined in the protocol.

According to the above, the controller 520 may control the transmitter 512 to sequentially transmit the power signal to the plurality of sensor modules 200 based on the plurality of allocation information in order to store the location information of the tire, the sensor identification code, and the tire identification code in the packet P according to the protocol.

For example, the controller 520 may control the transmitter 512 to first transmit the power signal to the first sensor module 210 of the first tire 12 having location information corresponding to the allocation number 1 in the order of the allocation number, and after the first sensor identification code and the first tire identification code are received through the receiver 514, may control the transmitter 512 to transmit the power signal to the second sensor module 220 attached to the second tire 14 having the location information corresponding to the allocation number 2.

As a result, as the power signals are sequentially transmitted to the plurality of sensor modules 200 in the order of the allocation numbers and the plurality of sensor identification codes and the plurality of tire identification codes are also sequentially received, as shown in FIG. 3, the packet P stores the first received communication module identification code in the receiver 514, and thereafter, according to the definition of the protocol, may store the location information of the first tire, the first identification code number, the first tire identification code, and the location information of the second tire, the second identification code number, and the second tire identification code.

Also, when calling any one of the plurality of allocation information, the controller 520 may extract tire location information, sensor identification code, and tire identification code corresponding to the allocation information called in the packet P. For example, when the allocation number 1 is called, the location information of the first tire 12, the first sensor identification code, and the first tire identification code stored in the packet P may be extracted.

Hereinafter, a sequence of forming the packet P according to the protocol of the tire sensor configuring device 500 according to the embodiment of the present disclosure will be described. In addition, it will be described that the allocation information is stored as a number. However, the present disclosure is not limited thereto, and it is applicable even when the allocation information is formed in characters.

First, the transmitter 512 of the tire sensor configuring device 500 transmits the communication module identification code request signal to the communication module 300 attached to the vehicle 1, and accordingly, the communication module 300 may transmit the communication module identification code stored therein to the receiver 514 of the tire sensor configuring device 500.

As the communication module identification code is received, the controller 520 may store the communication module identification code in the packet P.

Thereafter, the controller 520 may control the transmitter 512 based on the allocation number to receive the sensor identification code and tire identification code according to the protocol definition. Specifically, the controller 520 may control the transmitter 512 to transmit the power signal to the first sensor module 210 of the first tire 12 located in the location information of the tire corresponding to the allocation number 1, and control the receiver 514 to communicate with the tag of the first tire 12 located in the location information of the tire of which allocation number corresponds to No. 1.

Accordingly, as a power signal is transmitted from the transmitter 512 to the first sensor module 210, the first sensor module 210 may be operated, the receiver 514 may receive the first sensor identification code and communicate with the tag to receive the first tire identification code.

Moreover, the controller 520 may sequentially store the location information of the first tire 12 to which the first sensor module 210 to which the power signal is transmitted is attached, and the received first sensor identification code and first tire identification code, in the packet P.

Subsequently, the controller 520 may control the transmitter 512 to transmit a power signal to the second sensor module 220 of the second tire 14 located in the location information of the tire corresponding to the allocation number 2, and control the receiver 514 to communicate with the tag of the second tire 14 located in the location information of the tire of which the allocation number corresponds to No. 2.

Accordingly, as the power signal is transmitted from the transmitter 512 to the second sensor module 220, the second sensor module 220 may be operated, and the receiver 514 may receive the second sensor identification code and communicate with the tag to receive the second tire identification code.

Moreover, the controller 520 may sequentially store the location information of the second tire 14 to which the second sensor module 220 to which the power signal is transmitted is attached, and the received second sensor identification code and the second tire identification code in the packet P after the first sensor identification code and first tire identification code stored in advance.

When the tire identification codes of all tires of the vehicle 1 and the sensor identification codes of all sensor modules 200 are stored in packet P according to the protocol in the above manner, the controller 520 may transmit the packet P to the communication module 300 and transmit the packet P to the smart tire management server 400.

The storage unit 530 may store the location information of the plurality of tires 10 and the allocation information allocated to each of the plurality of location information.

Meanwhile, when any one of the sensor modules 200 attached to the plurality of tires 10 is damaged or does not work and is replaced with a new sensor module, the controller 520 may store an identification code regarding the new sensor module based on the allocation information. For example, when the first sensor module 210 provided in the first tire 12 is damaged and replaced with a new third sensor module, the controller 520 may control the transmitter 512 to transmit the power signal to the third sensor module. Moreover, the receiver 514 receives the sensor identification code of the third sensor module, the controller 520 may call the existing allocation number 1 to replace the first sensor identification code stored in the packet P with the third sensor identification code.

The tire sensor configuring device 500 according to another embodiment of the present disclosure may further include at least one of a display unit (not shown) and an operation unit (not shown). Here, the display unit may include a touch pad.

Accordingly, a user may operate the touch pad or the operation unit to store the location information of the plurality of tires 10, the plurality of sensor identification codes, and the plurality of tire identification codes in the packet P according to the protocol, call at least one of the plurality of allocation information, and control the transmitter 512 and receiver 514.

In addition, as the allocation information is called through the controller 520 by operating the touch pad or the operation unit, at least one of the allocation information, the location information of the plurality of tires 10, the plurality of sensor identification codes, and a plurality of tire identification codes may be displayed on the display unit.

In addition, the user may change the allocation information previously stored in the controller into numbers or characters by operating the display unit or the operation unit.

In addition, the user may change the order of allocation numbers allocated to the location information of each tire 10 by operating the display unit or the operation unit. For example, the number 1 allocated to the location information of the first tire 12 may be changed to number 2, and the number 2 allocated to the location information of the second tire 14 may be changed to number 1. In this case, the order of location information of the plurality of tires, the plurality of sensor identification codes, and the plurality of tire identification codes stored in the packet P for each tire location may be changed.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A tire sensor configuring device comprising:
a transceiver configured to receive a communication module identification code of a communication module provided in a vehicle to communicate with a smart tire management server, tire identification codes of a plurality of tires mounted to the vehicle, and sensor identification codes of sensor modules respectively attached to the plurality of tires; and
a controller configured to arrange the communication module identification code, the tire identification codes, and the sensor identification codes according to a protocol previously created in association with the smart tire management server to form a packet, the transceiver further configured to transmit the packet to the communication module.

2. The tire sensor configuration device of claim 1, wherein the packet further includes location information of the plurality of tires.

3. The tire sensor configuration device of claim 1, wherein the protocol defines a location where the tire identification code and the sensor identification code are stored in the packet for each tire.

4. The tire sensor configuration device of claim 1, wherein the transceiver includes:
a transmitter configured to transmit a communication module identification code request signal to the communication module; and
a receiver configured to receive the communication module identification code transmitted from the communication module in accordance with the communication module identification code request signal, the receiver further configured receive the sensor identification code and the tire identification code after the receiver receives the communication module identification code.

5. The tire sensor configuration device of claim 4, wherein the transmitter is configured to transmit a power signal for operating the sensor module to the sensor module after the receiver receives the communication module identification code.

6. A smart tire system comprising:
a communication module configured to communicate with a smart tire management server, provided in a vehicle including a plurality of tires, and configured to store a communication module identification code;
a sensor module provided in each of the plurality of tires and configured to store a sensor identification code;
a tag provided in each of the plurality of tires and configured to store a tire identification code; and
a tire sensor configuring device configured to communicate with the communication module, the sensor module, and the tag,
wherein the tire sensor configuring device includes:
a controller configured to arrange the communication module identification code transmitted from the communication module, the sensor identification code transmitted from the sensor module, and the tire identification code transmitted from the tag according to a protocol previously created in association with the smart tire management server to form a packet; and
a transceiver configured to transmit the packet to the communication module.

7. The smart tire system of claim 6, wherein the protocol defines a location where the tire identification code and the sensor identification code are stored in the packet for each tire.
